(19) United States
(12) Patent Application Publication
(10) Pub. No.: US 2008/0304178 A1
(43) Pub. Date: Dec. 11, 2008

(54) High-flow rate filter wall design

(75) Inventors: Haesung Kwon, San Jose, CA (US); Hyung Jai Lee, Cupertino, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/811,668

(22) Filed: Jun. 11, 2007

(51) Int. Cl. G11B 33/14

(52) U.S. Cl. 360/97.02

(57) ABSTRACT

A hard disk drive that includes a disk, a head, and a filter enclosed by a base plate and a cover plate. The base plate has a filter wall with a fore end and an aft end. The fore end of the filter wall has a tapered surface that extends to an apex. The distal end of the filter wall has a first filter attachment portion separated from a second filter attachment portion by a groove. The second filter attachment portion may be longer than the first filter attachment portion. The filter wall induces a flow of air that inhibits particle attachment to a reverse side of the filter.

### BACKGROUND OF THE INVENTION

1. Field of the Invention

The present invention relates to a filter wall of a hard disk drive.

2. Background Information

Hard disk drives have a housing that encloses the various components of the drive. The housing provides protection from handling and various environmental factors. The housing typically has a seal to prevent contaminants from flowing into the drive. It is difficult to completely seal a disk drive. Consequently, contaminants and particles may flow into the drive. Additionally, particles can become captured within the drive during the manufacturing process.

Some disk drives contain internal filters that capture particles inside the drive. FIG. 1 shows an internal filter assembly of the prior art. The assembly includes a filter 1 that is attached to a first filter wall 2 and a second filter wall 3. The disk(s) 4 within the disk drive is rotated to allow data access to the entire surfaces of the disk(s). Rotation of the disk(s) also circulates the air within the disk drive. Any particles within the drive can be driven into and captured by the filter 1. The first filter wall 1 has a curved contour surface 5 that minimizes drag on the flow of air. It has been found that particles may become attached to the reverse side 6 of the filter 1. The reverse side of the filter is located adjacent to the disk 4. The particles may become attached to a disk surface if it becomes detached from the reverse side 6 of the filter 1. It is highly undesirable to have particles on a disk surface. The particles can create errors in writing and reading data. The particles can also initiate undesirable movement of a head in the drive. It would be desirable to have a filter wall assembly that inhibits particle attachment to the reverse side of the filter 2. It would also be desirable to provide a filter wall assembly that maximizes air flow through the filter.

### BRIEF SUMMARY OF THE INVENTION

A hard disk drive that includes a disk, a head, and a filter enclosed by a base plate and a cover plate. The base plate has a filter wall with a fore end and an aft end. The fore end of the filter wall has a tapered surface that extends to an apex. The distal end of the filter wall has a first filter attachment portion separated from a second filter attachment portion by a groove.

### BRIEF DESCRIPTION OF THE DRAWINGS

FIG. 1 is an enlarged top view of a filter assembly of a hard disk drive of the prior art;

FIG. 2 is a top view of an embodiment of a hard disk drive;

FIG. 3 is an enlarged top view of a filter wall assembly of the hard disk drive.

### DETAILED DESCRIPTION

Disclosed is a hard disk drive that includes a disk, a head, and a filter enclosed by a base plate and a cover plate. The base plate has a filter wall with a fore end and an aft end. The fore end of the filter wall has a tapered surface that extends to an apex. The distal end of the filter wall has a first filter attachment portion separated from a second filter attachment portion by a groove. The second filter attachment portion may be longer than the first filter attachment portion. The filter wall induces a flow of air that inhibits particle attachment to a reverse side of the filter.

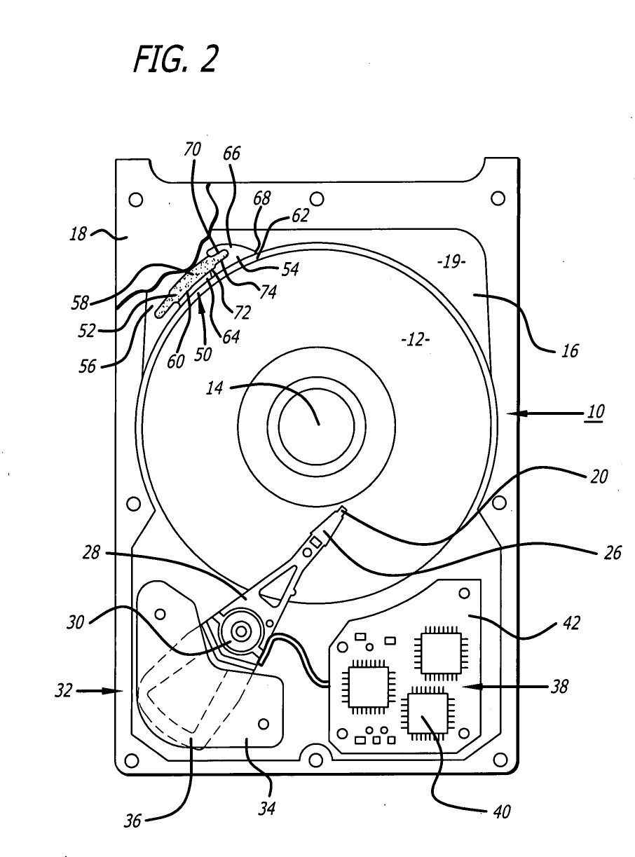

Referring to the drawings more particularly by reference numbers, FIG. 2 shows an embodiment of a hard disk drive 10 with the various internal components of the drive. The disk drive 10 may include one or more magnetic disks 12 that are rotated by a spindle motor 14. The spindle motor 14 may be mounted to a base plate 16. The disk drive 10 may further have a cover 18 that encloses the disks 12. The cover 18 and base plate 16 form a hard disk drive chamber 19.

The disk drive 10 may include a plurality of heads 20 located adjacent to the disks 12. The heads 20 may have separate write and read elements (not shown). The write element magnetizes the disk 12 to write data. The read element senses the magnetic fields of the disks 12 to read data. By way of example, the read element may be constructed from a magneto-resistive material that has a resistance which varies linearly with changes in magnetic flux.

Each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

As shown in FIG. 3, the disk drive includes a filter assembly 50. The filter assembly 50 includes a filter 52 that is attached to a first filter wall 54 and a second filter wall 56. The filter 52 is typically constructed from a material that will capture particles. During normal operation the disk 12 is rotated. Rotation of the disk create a circulation of air within the hard drive chamber 19. The circulating air can carry particles that become attached to and captured by the filter 52. The filter 52 can have a forward side 58 and a reverse side 60. It is desirable to inhibit particle attachment to the reverse side 60 of the filter 52.

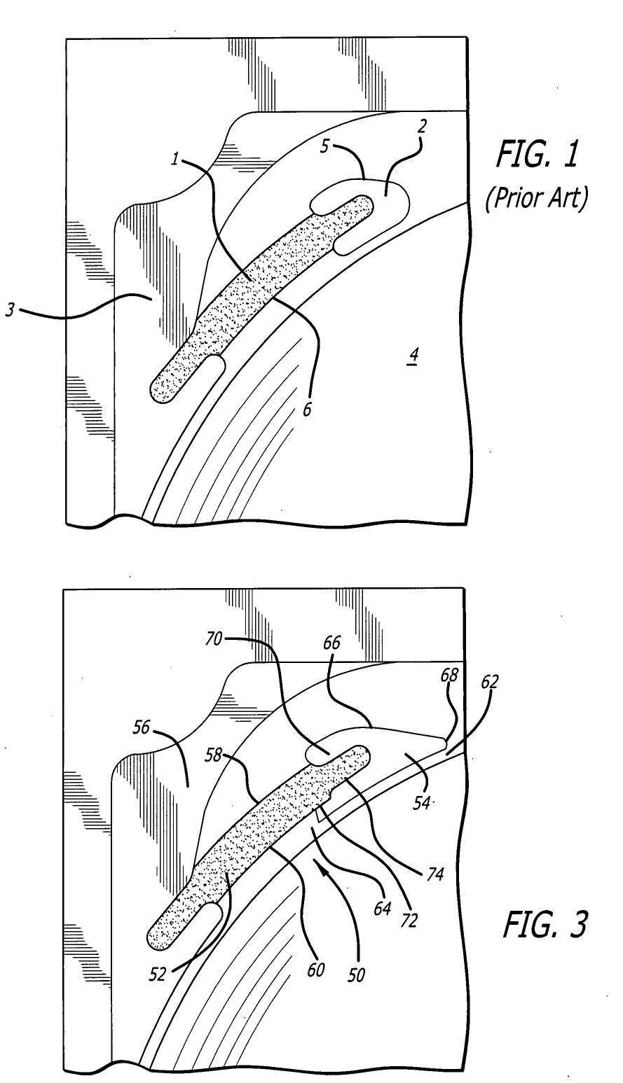

The first filter wall 54 includes a fore end 62 and an aft end 64. The fore end 62 of the filter wall 54 includes a tapered surface 66 that extends to an apex 68. The aft end 64 may include a first filter attachment portion 70 and a second filter attachment portion 72. The filter attachment portions 70 and 72 are separated by a groove 74. The second filter attachment portion 72 may be longer than the first filter attachment portion 70. Providing a curved contour and apex 68 with the longer second attachment portion 72, can induce an air flow that inhibits particle attachment to the reverse side 60 of the filter. The design of the first filter wall 54, particularly the inclusion of an apex, may also increase air flow from the design shown in FIG. 1. By way of example, through computer simulation the first filter wall design may allow for a mass flow in the filter of 3.54e-6 Kg/sec. This is to be compared with the design of FIG. 1 which allows a mass flow of 1.88e-6 Kg/sec.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a base plate that has a first filter wall, said first filter wall has a fore end and an aft end, said fore end of said first filter wall having a tapered surface that extends to an apex, said distal end having a first filter attachment portion separated from a second filter attachment portion by a groove;
a disk coupled to said base plate;
a head coupled to said disk;
a filter attached to said first filter wall; and,
a cover plate attached to said base plate to form a hard disk drive chamber.

2. The disk drive of claim 1, wherein said second filter attachment portion induces a flow of air within said hard disk drive chamber that inhibits particles from being attached to a reverse side of said filter.

3. The disk drive of claim 1, further comprising a second filter wall attached to said filter.

4. The disk drive of claim 1, wherein said second filter attachment portion is longer than said first filter attachment portion.

5. The disk drive of claim 4, wherein said second filter attachment portion is proximate to said disk.

6. A method for filtering a particle within a hard disk drive, comprising:
providing;
a base plate that has a first filter wall, the first filter wall has a fore end and an aft end, the fore end of the first filter wall having a tapered surface that extends to an apex, the distal end having a first filter attachment portion separated from a second filter attachment portion by a groove;
a disk coupled to the base plate;
a head coupled to the disk;
a filter attached to the first filter wall;
a cover plate attached to the base plate to form a hard disk drive chamber; and,
rotating the disk to induce a flow of air within the hard disk drive chamber so that a particle is captured by the filter.

7. The method of claim 6, wherein the second filter attachment portion induces air flow that inhibits the particle from being attached to a reverse side of the filter.

8. The method of claim 6, further comprising providing a second filter wall attached to the filter.

9. The method of claim 6, wherein the second filter attachment portion is longer than said the first filter attachment portion.

10. The method of claim 6, wherein the second filter attachment portion is proximate to the disk.
